(19) United States
(12) Patent Application Publication
(10) Pub. No.: US 2024/0348746 A1
(43) Pub. Date: Oct. 17, 2024

(54) DATA TRANSMISSION DEVICE AND DATA TRANSMISSION SYSTEM

(71) Applicant: SONY SEMICONDUCTOR SOLUTIONS CORPORATION, Kanagawa (JP)

(72) Inventor: Hideo MOROHASHI, Kanagawa (JP)

(21) Appl. No.: 18/294,337

(22) PCT Filed: Mar. 10, 2022
(86) PCT No.: PCT/JP2022/010491

§ 371 Date: Feb. 1, 2024

(30) Foreign Application Priority Data
Sep. 8, 2021 (JP) 2021-145925

(51) Int. Cl. H04N 7/10

(52) U.S. Cl. CPC H04N 7/102; H04N 7/108

(57) ABSTRACT

The present technology relates to a data transmission device and a data transmission system capable of achieving more suitable data transmission.

A data transmission device of the present technology includes: a common terminal connected to a transmission path that transmits a first signal and a second signal that is transmitted in a direction opposite to the first signal and has a frequency band different from a frequency band of the first signal; a receive circuit configured to receive the first signal from the transmission path via the common terminal; and a send circuit configured to send the second signal via the common terminal. The present technology can be applied to, for example, a data transmission system that transmits video data via an AC-coupled transmission path.

### TECHNICAL FIELD

The present technology relates to a data transmission device and a data transmission system, and more particularly to a data transmission device and a data transmission system capable of achieving more suitable data transmission.

### BACKGROUND ART

Some devices transmit a signal using a pair of signal lines in order to transmit a large amount of data at high speed. For example, Patent Document 1 describes a data transmission/reception device that transmits data using as a transmission path a coaxial cable in addition to a differential cable.

### CITATION LIST

### Patent Document

Patent Document 1: WO 2019/049524

### SUMMARY OF THE INVENTION

### Problems to be Solved by the Invention

Due to the recent further increase in data amount, more suitable data transmission is required.

The present technology has been made in view of such a situation, and is intended to be capable of achieving more suitable data transmission.

### Solutions to Problems

A data transmission device according to a first aspect of the present technology includes: a common terminal connected to a transmission path that transmits a first signal and a second signal that is transmitted in a direction opposite to the first signal and has a frequency band different from a frequency band of the first signal; a receive circuit configured to receive the first signal from the transmission path via the common terminal; and a send circuit configured to send the second signal via the common terminal.

A data transmission system according to a second aspect of the present technology includes: a data receive device including: a common terminal connected to a transmission path that transmits a first signal and a second signal that is transmitted in a direction opposite to the first signal and has a frequency band different from a frequency band of the first signal; a downstream signal receive circuit configured to receive the first signal from the transmission path via the common terminal; and an upstream signal send circuit configured to send the second signal via the common terminal; and a data send device including: a downstream signal send circuit that sends the first signal; and an upstream signal receive circuit that receives the second signal from the transmission path.

In the first aspect of the present technology, via the common terminal connected to a transmission path that transmits a first signal and a second signal that is transmitted in a direction opposite to the first signal and has a frequency band different from a frequency band of the first signal, the first signal from the transmission path is received, and the second signal is sent via the common terminal.

In the second aspect of the present technology, by a data receive device including the common terminal connected to a transmission path that transmits a first signal and a second signal that is transmitted in a direction opposite to the first signal and has a frequency band different from a frequency band of the first signal, the first signal from the transmission path is received via the common terminal, and the second signal is sent via the common terminal. Furthermore, the data send device sends the first signal and receives the second signal from the transmission path.

### BRIEF DESCRIPTION OF DRAWINGS

FIG. 1 is a block diagram illustrating an example of a configuration of a data transmission system according to an embodiment of the present technology.

FIG. 2 is a diagram illustrating a specific example of circuit configurations of a downstream signal send circuit and an upstream signal receive circuit of a source device.

FIG. 3 is a diagram illustrating a specific example of circuit configurations of an upstream signal send circuit and a downstream signal receive circuit of a conventional sink device.

FIG. 4 is a diagram illustrating a specific example of circuit configurations of an upstream signal send circuit and a downstream signal receive circuit of a sink device of the present technology.

FIG. 5 is diagrams illustrating an example of transmission bands of an upstream signal and a downstream signal.

FIG. 6 is a diagram illustrating flows of an upstream signal and a downstream signal in the data transmission system of the present technology.

### MODE FOR CARRYING OUT THE INVENTION

Hereinafter, modes for carrying out the present technology will be described. The description will be given in the following order.

### 1. Overview of Data Transmission System

### 2. Example of Circuit Configuration

### 1. Overview of Data Transmission System

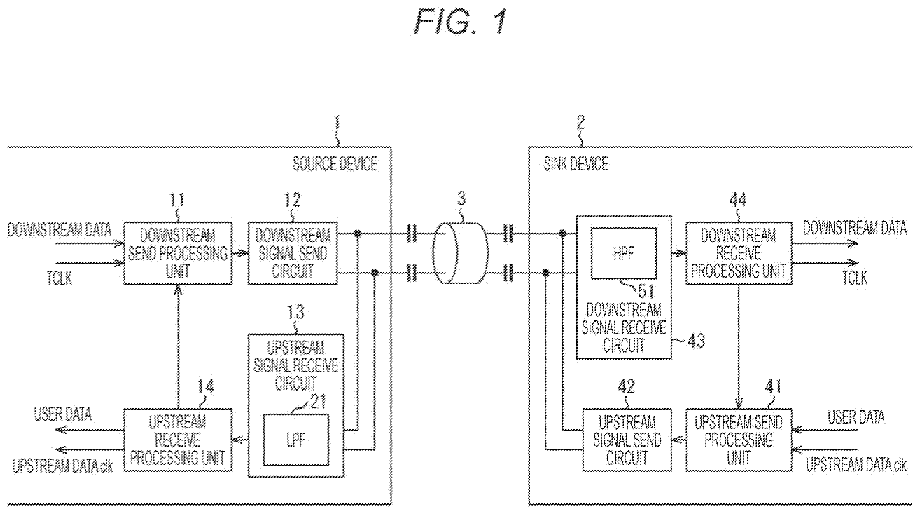

FIG. 1 is a block diagram illustrating an example of a configuration of a data transmission system according to an embodiment of the present technology.

A data transmission system according to an embodiment of the present technology is a system that transmits a differential signal, an in-phase signal, and the like from a send-side device (source device 1) to a receive-side device (sink device 2) using a pair of signal lines. High-speed data transfer from the source device 1 to the sink device 2 is performed in the transmission of a signal using the pair of signal lines.

The data transmission system sends and receives digital video and audio data using, for example, a serial data transmission technology. As the digital video and audio data, a moving image such as a 24-bit gradation Video Graphics Array (VGA), Wide VGA (WVGA), Super VGA (SVGA), extended Graphics Array (XGA), Wide XGA (WXGA), Super XGA (SXGA), and Ultra XGA (UXGA), is transmitted on the basis of, for example, Gigabit Video Interface (GVIF) (registered trademark) standard.

As illustrated in FIG. 1, the data transmission system includes a source device 1, a sink device 2, and a transmission path 3 that is a path of data to be transmitted. In the following description, a direction from the source device 1 to the sink device 2 is referred to as a downstream, and a direction from the sink device to the source device is referred to as an upstream. Hereinafter, a general case where the downstream signal includes a video signal or the like and the upstream signal includes a low-speed signal such as a control signal will be described. The transmission path 3 includes, for example, a shielded pair cable.

The source device 1 includes a downstream send processing unit 11, a downstream signal send circuit 12, an upstream signal receive circuit 13, and an upstream receive processing unit 14.

The downstream send processing unit 11 determines data to be sent from the source device 1 to the sink device 2, and supplies the determined data to the downstream signal send circuit 12. For example, in a case where the downstream data are to be sent to the sink device 2, the downstream send processing unit 11 synchronizes the downstream data with a send clock TCLK, which is a clock for transmission, and supplies the synchronized downstream data to the downstream signal send circuit 12.

Furthermore, in a case where a reference clock send instruction is supplied from the upstream receive processing unit 14, the downstream send processing unit 11 supplies a clock obtained by dividing the send clock TCLK by N to the downstream signal send circuit 12 as a reference clock.

The downstream signal send circuit 12 generates a signal for serially transferring the signal supplied from the downstream send processing unit 11 through the transmission path 3. For example, the downstream signal send circuit 12 generates a pair of signals (differential signals) having phases opposite to each other, and sends the pair of signals to the sink device 2 via the transmission path 3.

The upstream signal receive circuit 13 includes a low-pass filter (LPF) 21. The LPF 21 is a filter circuit that attenuates a signal output from the downstream signal send circuit 12 and passes a signal transmitted from the sink device 2 through the transmission path 3.

In the data transmission system of the present technology, the downstream signal transmitted from the source device 1 to the sink device 2 and the upstream signal transmitted from the sink device 2 to the source device 1 have different frequency bands from each other. Here, the downstream signal is transmitted at a high frequency, and the upstream signal is transmitted at a low frequency. Therefore, the LPF 21 has a characteristic of separating the upstream signal and the downstream signal depending on frequency by passing the upstream signal and attenuating the downstream signal.

The upstream signal receive circuit 13 supplies the signal that has passed through the LPF to the upstream receive processing unit 14.

The upstream receive processing unit 14 analyzes the signal supplied from the upstream signal receive circuit 13 and outputs an analysis result. For example, in a case where the signal supplied by the upstream signal receive circuit 13 is data of the upstream signal, which is here referred to as user data, the upstream receive processing unit 14 supplies the user data to a circuit (not illustrated) that uses the user data in the source device 1. The upstream receive processing unit 14 supplies the upstream data clk to a circuit (not illustrated) that uses the upstream data clk in the source device 1.

Furthermore, in a case where the signal supplied by the upstream signal receive circuit 13 is a signal requesting a reference clock (reference clock requesting signal), the upstream receive processing unit 14 supplies the reference clock send instruction to the downstream send processing unit 11.

A configuration of the upstream receive processing unit 14 is not limited to a specific configuration. For example, the upstream receive processing unit 14 is configured to have a function of detecting data by, for example, comparing the signal supplied from the upstream signal receive circuit 13 with a reference potential, which is a predetermined potential, and comparing a comparison result with a predetermined clock generated in the source device 1.

The sink device 2 includes an upstream send processing unit 41, an upstream signal send circuit 42, a downstream signal receive circuit 43, and a downstream receive processing unit 44.

The upstream send processing unit 41 determines data to be sent from the sink device 2 to the source device 1, and supplies the determined data to the upstream signal send circuit 42. For example, in a case where a reference clock requesting send instruction is supplied from the downstream receive processing unit 44, the upstream send processing unit 41 supplies the reference clock requesting signal) to the upstream signal send circuit 42.

Furthermore, in a case where the reference clock requesting send instruction is not supplied and the user data that is the data to be sent is supplied, the upstream send processing unit 41 supplies the user data to the upstream signal send circuit 42. In this case, the upstream send processing unit 41 synchronizes the user data with an upstream send clock (upstream data clk) which is a clock for sending data in an upstream direction, and supplies the synchronized user data to the upstream signal send circuit 42.

The upstream signal send circuit 42 generates a signal to transfer through the transmission path 3 the signal supplied from the upstream send processing unit 41. For example, the upstream signal send circuit 42 generates a differential signal and supplies the differential signal to the upstream signal receive circuit 13 of the source device 1 via the transmission path 3.

The downstream signal receive circuit 43 includes a high-pass filter (HPF) 51. The HPF 51 is a filter circuit that attenuates a signal output from the upstream signal send circuit 42 and passes a signal transmitted from the source device 1 through the transmission path 3. As described above, in the data transmission system of the present technology, the downstream signal and the upstream signal have different frequency bands from each other. Therefore, the HPF 51 has a characteristic of separating the upstream signal and the downstream signal depending on frequency by attenuating the upstream signal and passing the downstream signal.

The downstream signal receive circuit 43 receives a signal supplied via the transmission path 3 and passing through the HPF 51. That is, the downstream signal receive circuit 43 receives a signal sent from the downstream signal send circuit 12 of the source device 1 and supplies the signal to the downstream receive processing unit 44.

The downstream receive processing unit 44 analyzes the signal supplied from the downstream signal receive circuit 43 and outputs an analysis result. For example, in a case where the downstream data has been transmitted, the downstream receive processing unit 44 supplies the downstream data and the send clock TCLK to a circuit (not illustrated) that uses the downstream data in the sink device 2.

Furthermore, in a case where it is necessary to receive the reference clock, the downstream receive processing unit 44 supplies a signal (reference clock requesting send instruction) for sending the reference clock requesting signal to the upstream send processing unit 41.

In a case where the reference clock has been received, the downstream receive processing unit 44 synchronizes with the reference clock a clock (standard clock) used when the downstream receive processing unit 44 detects the downstream data. The downstream receive processing unit 44 supplies the send clock TCLK to a circuit (not illustrated) that uses the send clock TCLK in the sink device 2.

### 2. Example of Circuit Configuration

### Example of Circuit Configuration of Source Device 1

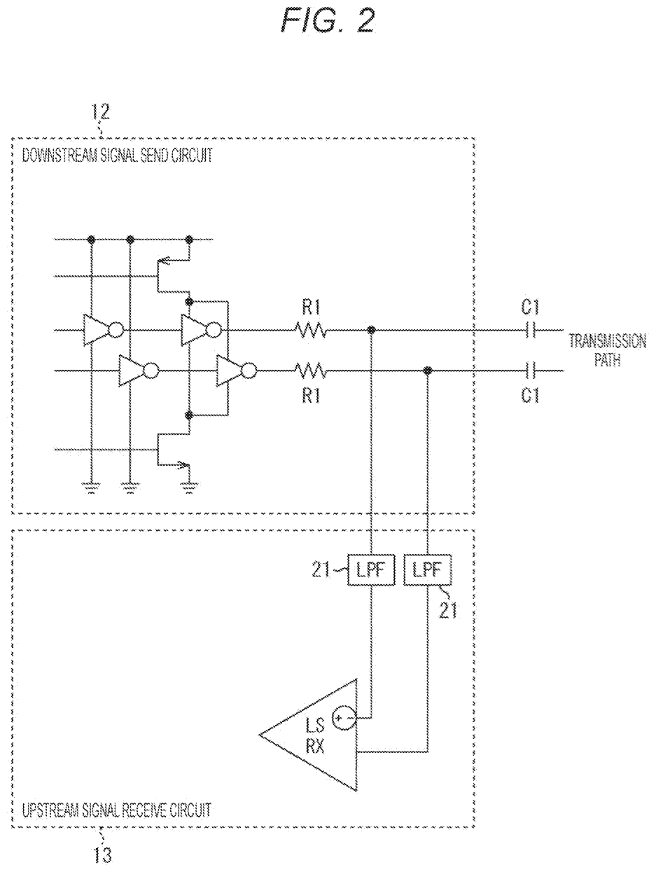

FIG. 2 is a diagram illustrating a specific example of circuit configurations of a downstream signal send circuit 12 and an upstream signal receive circuit 13 of a source device 1.

The downstream signal send circuit 12 is, for example, a differential circuit. Resistive elements R1 are provided at a subsequent stage of the downstream signal send circuit 12.

The downstream signal is also input to the upstream signal receive circuit 13. Therefore, the LPF 21 is provided at a preceding stage to attenuate a downstream signal component, so that the upstream signal receive circuit 13 can receive only the upstream signal.

### Example of Circuit Configuration of Sink Device 2

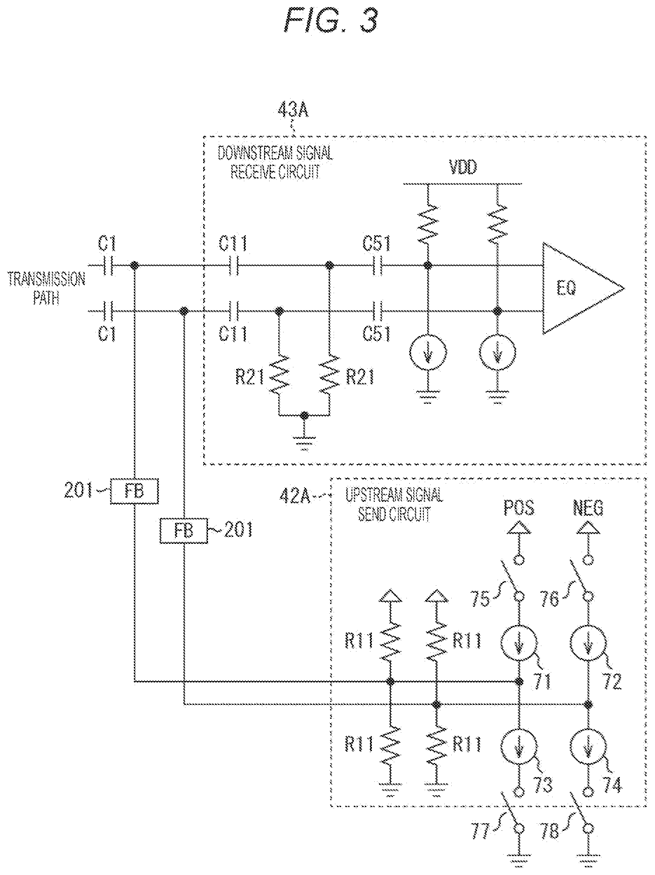

Here, before a circuit configuration of the sink device 2 of the present technology is described in detail, a circuit configuration of a conventional sink device will be described. FIG. 3 is a diagram illustrating a specific example of circuit configurations of an upstream signal send circuit 42A and a downstream signal receive circuit 43A of a conventional sink device.

The upstream signal send circuit 42A has a push-pull configuration, and is configured such that a current flows in and out by switching switches 75 to 78 with respect to current sources 71 to 74. Each of the switches 75 to 78 includes, for example, a metal-oxide-semiconductor field-effect transistor (MOSFET).

The upstream signal send circuit 42A is provided with resistive elements R11 for dividing a voltage of the power supply in order to fix DC levels when currents are cut off. These currents flow through the transmission path 3 to the resistive elements R1 of the downstream signal send circuit 12, and a voltage changes.

Ferrite beads (FBs) 201 are provided at a subsequent stage of the upstream signal send circuit 42A. The FBs 201 are elements having a high impedance at a high frequency and a low impedance at a low frequency, and are inserted to reduce an influence of a load on the upstream signal send circuit 42A.

An input of the downstream signal receive circuit 43A is terminated at the resistive elements R21. A preceding stage of the resistive elements R21 includes capacitive elements C11, which constitute an HPF. A further preceding stage includes capacitive elements C51, which constitute an additional HPF, for cutting off a DC component. These HPFs attenuate an upstream signal input to the downstream signal receive circuit 43A.

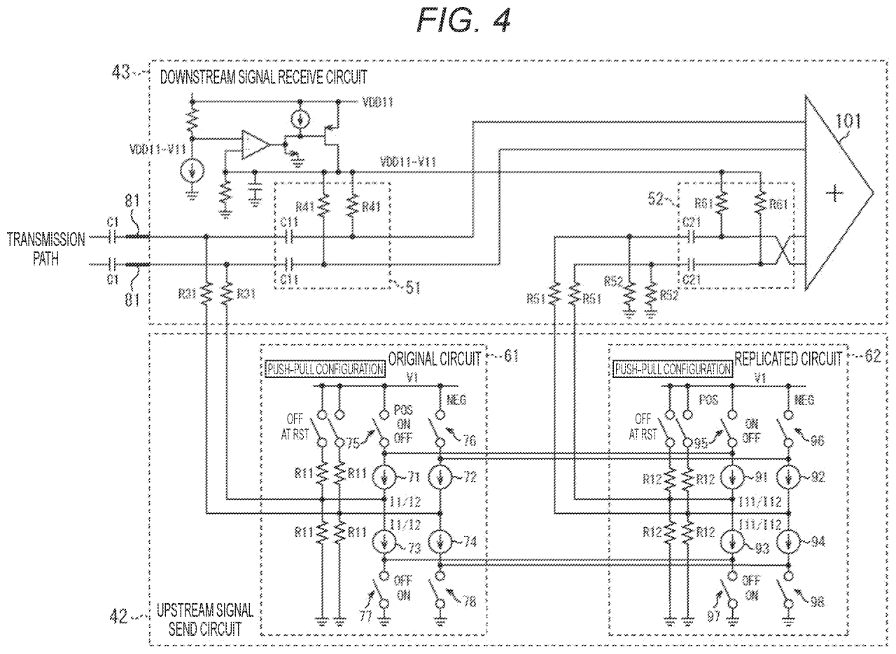

FIG. 4 is a diagram illustrating a specific example of circuit configurations of an upstream signal send circuit 42 and a downstream signal receive circuit 43 of a sink device 2 of the present technology.

Conventional sink devices must be provided with the FBs 201 outside an integrated circuit (IC) having the upstream signal send circuit 42A and the downstream signal receive circuit 43A provided. The FBs 201 provided outside the IC causes an output terminal of the upstream signal send circuit 42A and an input terminal of the downstream signal receive circuit 43A to be provided as separate terminals in the IC. As a result, the number of terminals of the IC increases. Furthermore, components such as the FBs 201 provided outside the output terminal of the upstream signal send circuit 42A requires a mounting area including peripheral components.

Mounting a component having a same specification as the FBs 201 in the IC requires an inductor in a class of several hundred nH. It is not practical to provide the inductor in the IC. Therefore, the sink device 2 of the present technology has resistive elements R31 provided in the IC instead of the FBs 201, as illustrated in FIG. 4. Mounting the component in the IC allows the upstream signal send circuit 42 and the downstream signal receive circuit 43 to be connected to the transmission path 3 via a common terminal 81 of the IC. That is, the upstream signal send circuit 42 sends an upstream signal via the common terminal 81, and the downstream signal receive circuit 43 receives a downstream signal from the transmission path 3 via the common terminal 81. Therefore, the number of terminals of the IC can be reduced. Furthermore, reducing the number of peripheral components allows the mounting area to be reduced.

However, unlike the FBs 201, the resistive elements R31 cannot reduce the impedance at the low frequency and cannot increase the impedance at the high frequency, and have the constant impedance regardless of the frequency. A resultant voltage amplitude that increases at an end of the upstream signal send circuit 42 reduces a performance of a MOS transistor included in the current source, which prevents a resistance value of the resistive elements R31 from being increased. For this reason, it is difficult to achieve isolation between a downstream side and an upstream side, compared to the conventional. In other words, an upstream signal component easily interferes with the downstream signal.

Therefore, the sink device 2 of the present technology is provided with a circuit that cancels the upstream signal component included in the downstream signal by generating an opposite-phase signal from a replicated circuit 62 of an original circuit 61 that generates the upstream signal and adding the opposite-phase signal to the downstream signal. Providing such a circuit allows the downstream signal receive circuit 43 to output the downstream signal from which the upstream signal component has been removed to a subsequent stage.

First, a specific circuit configuration of the upstream signal send circuit 42 will be described. The upstream signal send circuit 42 includes the original circuit 61 and the replicated circuit 62.

The original circuit 61 has a circuit configuration similar to the configuration of the upstream signal send circuit 42A described with reference to FIG. 3. For example, the switch 75 and the switch 78 are turned on in a high state and turned off in a low state. The switch 76 and the switch 77 are turned on in a Low state and turned off in a High state.

The replicated circuit 62 is a circuit of a replica in which an output current of the original circuit 61 is reduced at a predetermined reduction ratio. The replicated circuit 62 includes a circuit in which the output current of the original circuit 61 is reduced to, for example, 1/40. Including a circuit in which the output current is downscaled allows a circuit area of the replicated circuit 62 to be reduced. The replicated circuit 62 can also include a circuit having a same size as a size of the original circuit 61.

The replicated circuit 62, similar to the original circuit 61, has a push-pull configuration, and is configured such that a current flows in and out by switching switches 95 to 98 with respect to current sources 91 to 94. Output currents I11/I12 of the current sources 91 to 94 have values obtained by reducing output currents I1/I2 of the current sources 71 to 74 of the original circuit 61 at a reduction ratio of 1/40.

Each of the switches 95 to 98 includes, for example, a MOSFET. For example, the switch 95 and the switch 98 are turned on in a high state and turned off in a low state. The switch 96 and the switch 97 are turned on in a Low state and turned off in a High state. The replicated circuit 62 is provided with resistive elements R12 corresponding to the resistive elements R11.

Next, a specific circuit configuration of the downstream signal receive circuit 43 will be described. The input of the downstream signal receive circuit 43 is connected to the output of the original circuit 61 via the resistive elements R31. The input of the downstream signal receive circuit 43 is terminated at the resistive elements R41. A preceding stage of the resistive elements R41 includes capacitive elements C11, which constitute the HPF 51 on an original circuit 61 side. The HPF 51 attenuate an upstream signal input to the downstream signal receive circuit 43 from the original circuit 61.

The downstream signal receive circuit 43A described with reference to FIG. 3 has the resistive elements R21 grounded to GND. This configuration is disadvantageous in building a high frequency circuit because a negative-channel MOS (NMOS) cannot be provided at an input of a circuit at a next stage. Therefore, an HPF including the capacitive elements C51 at a subsequent stage cuts a DC component, and a VDD-referenced bias circuit is separately provided.

The downstream signal receive circuit 43 of the present technology can also have a similar configuration, but two stages of capacitive elements entering into in a series may increase a ratio of signals attenuated by parasitic capacitance. In order to avoid this, the resistive elements R41 are grounded by a low dropout (LDO) circuit biased to VDD-V11. As a result, a bias of the circuit at the next stage can be created with a single stage of the capacitive elements.

Resistive elements R51 are provided on an output side of the replicated circuit 62. An output of the replicated circuit 62 is terminated by resistive elements R52 and terminated by resistive elements R61 via capacitive elements C21. The capacitive elements C21 and the resistive elements R61 constitute an HPF 52 on a replicated circuit 62 side. The HPF 52 attenuates an output signal from the replicated circuit 62 and input to the downstream signal receive circuit 43. The resistive elements R61 are also grounded by an LOD circuit biased to VDD-V11.

The capacitive elements C11 included in the HPF 51 on the original circuit 61 side has a capacitance value that requires a proportionate area when mounted in the IC. The capacitive elements C21 that are included in the HPF 52 on the replicated circuit 62 side and have a capacitance value reduced to 1/40, the reduction ratio of the output current of the replicated circuit 62, reduce a mounting area for the capacitive elements C11 in the downstream signal receive circuit 43.

Furthermore, in the downstream signal receive circuit 43, in order to achieve a cutoff frequency HPF-fc of the HPF 52 that is a same as a cutoff frequency HPF-fc of the HPF 51 expressed by a following equation 1, the resistance value of the resistive elements R61 included in the HPF 52 is adjusted to be 40 times the resistance value of the resistive elements R41 included in the HPF 51. The cutoff frequency HPF-fc of the HPF 52 is expressed by a following equation 2.

$$\begin{matrix}[ Equation 1 ] & \\ HPF - fc = \frac{1}{2 * π * C 11 * R 41} & ( 1 )\end{matrix}$$

$$\begin{matrix}[ Equation 2 ] & \\ & ( 2 )\end{matrix}$$

$$HPF - fc = \frac{1}{2 * π * C 21 * R 61} = \frac{1}{2 * π * \frac{C 11}{40} * R 41 * 40} = \frac{1}{2 * π * C 11 * R 41}$$

Note that, because the output current of the replicated circuit 62 is adjusted to have a value of 1/40 of the output current of the original circuit 61, a voltage level of an input of the HPF 52 on the replicated circuit 62 side needs to be adjusted by the resistive elements R51 and R52 on the basis of a voltage level of an input of the HPF 51 on the original circuit 61 side.

For example, the resistance values of the resistive elements R51 and the resistive elements R52 are determined such that the voltage level of the input of the HPF 52 on the replicated circuit 62 side expressed by the following equation 3 is substantially a same as the voltage level of the input of the HPF 51 on the original circuit 61 side expressed by the following equation 4. Note that, in equations 3 and 4, IBC denotes the output current of the original circuit 61.

$$\begin{matrix}[ Equation 3 ] & \\ \frac{IBC}{40} * ( \frac{R 12}{2} / / ( R 51 + R 52 ) ) * \frac{R 52}{R 52 + R 51} & ( 3 )\end{matrix}$$

$$\begin{matrix}[ Equation 4 ] & \\ IBC * ( \frac{R 11}{2} / / ( R 21 + R 1 ) ) * \frac{R 1}{R 21 + R 1} & ( 4 )\end{matrix}$$

In the downstream signal receive circuit 43, the downstream signal including the upstream signal component that has passed through the HPF 51 and the opposite-phase signal of the output signal from the replicated circuit 62 that has passed through the HPF 52 are supplied to a canceller circuit 101.

The canceller circuit 101 adds the opposite-phase signal of the output signal from the replicated circuit 62 to the downstream signal.

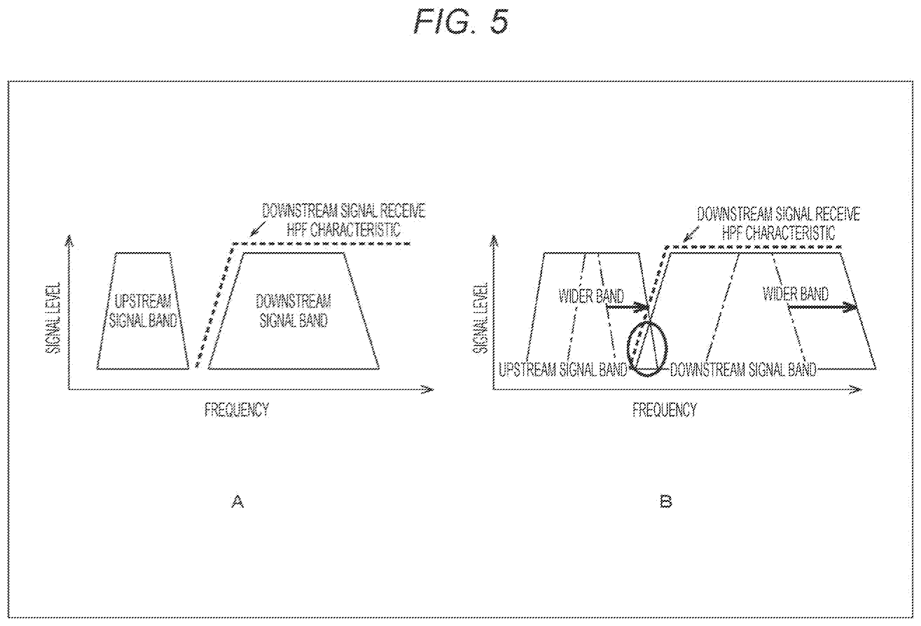

FIG. 5 is diagrams illustrating an example of transmission bands of an upstream signal and a downstream signal. Broken lines in FIG. 5 indicate a filter characteristic of an HPF.

Diagram A in FIG. 5 illustrates an example of transmission bands for the upstream signal and the downstream signal in a conventional data transmission system. Conventionally, as illustrated in diagram A in FIG. 5, a frequency band in an attenuation band of the HPF provided in the downstream signal receive circuit 43A is used as a transmission band for the upstream signal, and a frequency band in a pass band and a transition band of the HPF is used as a transmission band for the downstream signal.

Due to a recent trend toward video having higher resolution, each of the transmission bands of the upstream signal and the downstream signal is widened, as illustrated in diagram B in FIG. 5. Furthermore, as described above, the sink device 2 of the present technology has the resistive elements R31, instead of the FBs 201, provided between the upstream signal send circuit 42 and the downstream signal receive circuit 43, resulting in the downstream signal easily interfered with by the upstream signal component.

Therefore, as indicated by encircling with an ellipse in FIG. 5, a frequency band of, for example, the transition band of the HPF 51 provided in the downstream signal receive circuit 43 is used as a part of the transmission band for the upstream signal, and the upstream signal cannot be completely attenuated by the HPF 51. Using only the HPF 51 to separate the upstream signal and the downstream signal causes the upstream signal component having passed through the HPF 51 to be noise to the downstream signal receive circuit 43, resulting in a deteriorated reception sensitivity of the downstream signal receive circuit 43.

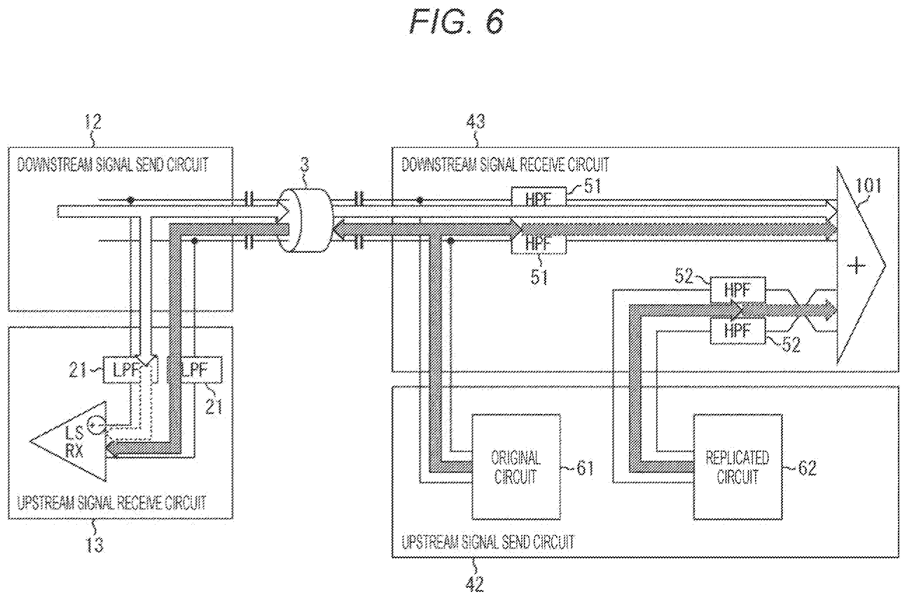

FIG. 6 is a diagram illustrating flows of an upstream signal and a downstream signal in the data transmission system of the present technology.

As indicated by white arrows in FIG. 6, the downstream signal from downstream signal send circuit 12 passes through the HPF 51 and is supplied to the canceller circuit 101 of the downstream signal receive circuit 43. In addition, a part of the downstream signal passes through the LPF 21 and is supplied to the upstream signal receive circuit 13.

As indicated by colored arrows in FIG. 6, the upstream signal from the original circuit 61 of the upstream signal send circuit 42 passes through the LPF 21 and is supplied to the upstream signal receive circuit 13. In addition, a part of the upstream signal passes through HPF 51 and is supplied to the canceller circuit 101.

Moreover, as indicated by colored arrows in FIG. 6, a part of the output signal from the replicated circuit 62 of the upstream signal send circuit 42 has passed through the HPF 52, and the opposite-phase signal of the output signal that has passed through the HPF 52 is supplied to the canceller circuit 101.

The canceller circuit 101 adds the signal having passed through the HPF 51 to the opposite-phase signal of the signal having passed through the HPF 52, enabling cancellation of the upstream signal component included in the signal having passed through the HPF 51 to reduce noise.

Furthermore, as described above, the downstream signal receive circuit 43 has the resistive elements R41 that are included in the HPF 51 and grounded by the LDO circuit, allowing the HPF 51 to be arranged with the single stage of capacitive elements and allowing prevention of signal attenuation due to the parasitic capacitance.

As described above, it is possible to reduce noise generated when a high-frequency signal is transmitted via the transmission path 3 of a bidirectional transmission path AC-coupled using a pair of signal lines. Therefore, even in a case where a frequency difference between the transmission bands of the upstream signal and the downstream signal is small, high-speed communication can be achieved using a high-frequency signal, and more suitable data transmission can be achieved.

Note that in the present specification, a system means a set of a plurality of components (devices, modules (parts), and the like), and all components may or may not be in the same enclosure. Therefore, a plurality of devices received in separate enclosures and connected via a network and a device in which a plurality of modules is received in an enclosure are both systems.

Note that, the effects described in the present specification are mere examples and are not limiting, and other effects may be produced.

### Example of Configuration Combinations

The present technology may also have the following configurations.

(1)

A data transmission device including:
a common terminal connected to a transmission path that transmits a first signal and a second signal that is transmitted in a direction opposite to the first signal and has a frequency band different from a frequency band of the first signal;
a receive circuit configured to receive the first signal from the transmission path via the common terminal; and
a send circuit configured to send the second signal via the common terminal.

(2)

The data transmission device according to (1),
in which the receive circuit includes a filter circuit configured to separate the first signal and the second signal that are transmitted via the common terminal, depending on a frequency.

(3)

The data transmission device according to (2),
in which the filter circuit is configured to attenuate the second signal.

(4)

The data transmission device according to (3),
in which the filter circuit is a first HPF including first capacitors and first resistors.

(5)

The data transmission device according to (4),
in which the receive circuit further includes a canceller circuit that is configured to add an opposite-phase signal of an output signal from a replicated circuit of the send circuit to a signal that has passed through the first HPF.

(6)

The data transmission device according to (5),
in which the send circuit includes the replicated circuit.

(7)

The data transmission device according to (5) or (6),
in which the replicated circuit is a circuit in which an output current of the send circuit is reduced at a predetermined reduction ratio.

(8)

The data transmission device according to (7),
in which the receive circuit further includes a second HPF having a same cutoff frequency as a cutoff frequency of the first HPF, and
the canceller circuit is configured to add an opposite-phase signal of an output signal from the replicated circuit that has passed through the second HPF to a signal that has passed through the first HPF.

(9)

The data transmission device according to (8),
in which the second HPF includes: second capacitors having a capacitance value obtained by reducing a capacitance value of the first capacitors at a reduction ratio of an output current of the replicated circuit; and second resistors having a resistance value obtained by multiplying a resistance value of the first resistors by a magnification ratio corresponding to the reduction ratio of the output current of the replicated circuit.

(10)

The data transmission device according to (8) or (9),
in which the receive circuit further includes resistors configured to adjust a voltage level input to the second HPF on the basis of a voltage level of the output signal of the replicated circuit to a voltage level of the second signal transmitted from the send circuit via the common terminal.

(11)

The data transmission device according to any one of (4) to (10),
in which the first resistors are grounded via an LDO circuit biased to a predetermined voltage.

(12)

The data transmission device according to any one of (1) to (11),
in which data transmitted through the transmission path is video data.

(13)

The data transmission device according to (12), including
a device that receives the video data.

(14)

The data transmission device according to (12) or (13),
in which the video data is transmitted on the basis of Gigabit Video Interface (GVIF) (registered trademark) standard.

(15)

A data transmission system including:
a data receive device including:
a common terminal connected to a transmission path that transmits a first signal and a second signal that is transmitted in a direction opposite to the first signal and has a frequency band different from a frequency band of the first signal;
a downstream signal receive circuit configured to receive the first signal from the transmission path via the common terminal; and
an upstream signal send circuit configured to send the second signal via the common terminal; and
a data send device including:
a downstream signal send circuit that sends the first signal; and
an upstream signal receive circuit that receives the second signal from the transmission path.

### REFERENCE SIGNS LIST

1 Source device
2 Sink device
3 Transmission path
11 Downstream send processing unit
12 Downstream signal send circuit
13 Upstream signal receive circuit
14 Upstream receive processing unit
21 LPF
41 Upstream send processing unit
42 Upstream signal send circuit
43 Downstream signal receive circuit
44 Downstream receive processing unit
51, 52 HPF
61 Original circuit
62 Replicated circuit
81 Common terminal
101 Canceller circuit

1. A data transmission device comprising:
a common terminal connected to a transmission path that transmits a first signal and a second signal that is transmitted in a direction opposite to the first signal and has a frequency band different from a frequency band of the first signal;
a receive circuit configured to receive the first signal from the transmission path via the common terminal; and
a send circuit configured to send the second signal via the common terminal.

2. The data transmission device according to claim 1,
wherein the receive circuit comprises a filter circuit configured to separate the first signal and the second signal that are transmitted via the common terminal, depending on a frequency.

3. The data transmission device according to claim 2,
wherein the filter circuit is configured to attenuate the second signal.

4. The data transmission device according to claim 3,
wherein the filter circuit is a first HPF comprising first capacitors and first resistors.

5. The data transmission device according to claim 4,
wherein the receive circuit further comprises a canceller circuit that is configured to add an opposite-phase signal of an output signal from a replicated circuit of the send circuit to a signal that has passed through the first HPF.

6. The data transmission device according to claim 5,
wherein the send circuit comprises the replicated circuit.

7. The data transmission device according to claim 5,
wherein the replicated circuit is a circuit in which an output current of the send circuit is reduced at a predetermined reduction ratio.

8. The data transmission device according to claim 7,
wherein the receive circuit further comprises a second HPF having a same cutoff frequency as a cutoff frequency of the first HPF, and
the canceller circuit is configured to add an opposite-phase signal of an output signal from the replicated circuit that has passed through the second HPF to a signal that has passed through the first HPF.

9. The data transmission device according to claim 8,
wherein the second HPF comprises: second capacitors having a capacitance value obtained by reducing a capacitance value of the first capacitors at a reduction ratio of an output current of the replicated circuit; and second resistors having a resistance value obtained by multiplying a resistance value of the first resistors by a magnification ratio corresponding to the reduction ratio of the output current of the replicated circuit.

10. The data transmission device according to claim 8,
wherein the receive circuit further comprises resistors configured to adjust a voltage level input to the second HPF on a basis of a voltage level of the output signal of the replicated circuit to a voltage level of the second signal transmitted from the send circuit via the common terminal.

11. The data transmission device according to claim 4,
wherein the first resistors are grounded via an LDO circuit biased to a predetermined voltage.

12. The data transmission device according to claim 1,
wherein data transmitted through the transmission path is video data.

13. The data transmission device according to claim 12, comprising
a device that receives the video data.

14. The data transmission device according to claim 12,
wherein the video data is transmitted on a basis of Gigabit Video Interface (GVIF) (registered trademark) standard.

15. A data transmission system comprising:
a data receive device comprising:
a common terminal connected to a transmission path that transmits a first signal and a second signal that is transmitted in a direction opposite to the first signal and has a frequency band different from a frequency band of the first signal;
a downstream signal receive circuit configured to receive the first signal from the transmission path via the common terminal; and
an upstream signal send circuit configured to send the second signal via the common terminal; and
a data send device comprising:
a downstream signal send circuit that sends the first signal; and
an upstream signal receive circuit that receives the second signal from the transmission path.
